(19) United States
(12) Patent Application Publication
(10) Pub. No.: US 2017/0176228 A1
(43) Pub. Date: Jun. 22, 2017

(54) DRILLING FLUID LOSS RATE PREDICTION

(71) Applicant: Schlumberger Technology Corporation, Houston, TX (US)

(72) Inventor: Francis Elisabeth, Fracc Bonanza (MX)

(21) Appl. No.: 14/979,343

(22) Filed: Dec. 22, 2015

(51) Int. Cl. G01F 1/34; G01V 1/28; E21B 21/08; G01V 1/38; E21B 41/00; E21B 49/00

(52) U.S. Cl. CPC G01F 1/34; E21B 41/0092; E21B 49/00; E21B 21/08; G01V 1/38; G01V 1/282; E21B 47/12

(57) ABSTRACT

Methods, computing systems, and computer-readable media for predicting drilling fluid loss rate. The method includes obtaining data representing a drilling fluid loss rate from a first well while drilling the first well, and obtaining a mechanical earth model of a subterranean volume. The first well extends at least partially through the subterranean volume, and the mechanical earth model includes data representing formation strain in the subterranean volume. The method also includes determining a relationship between the formation strain and the drilling fluid loss rate, and predicting a drilling fluid loss rate in a second well extending through the subterranean volume based at least in part on the relationship.

### BACKGROUND

Mechanical Earth Models (MEMs) are used in oilfield modeling and simulation to predict the behavior of a subterranean volume of interest with change of stresses, strain and pressure, e.g., in different scenarios. Specifically, such models may, for example, be employed to predict events or hazards that may occur during drilling or a formation's response to hydraulic fracturing, injection, depletion, or other operations.

When planning to drill in an oilfield, the MEMs may be considered and employed to pick a suitable drilling location, wellbore trajectory, etc. One aspect of a drilling operation is its usage of drilling mud. Such drilling mud is often circulated through the interior of the drill string out through the drill bit, and then back to the surface through the annulus between the drill string and the wellbore. Drilling mud serves several purposes. The drilling mud removes cuttings, cools and lubricates, and also maintains a pressure within the wellbore, which facilitates the drilling process. During drilling, however, mud loss can occur, sometimes through abrupt mud-loss events, but also through more gradual loss, e.g., as it is absorbed into the subsurface rock. One cause for mud loss while drilling are due to an increase of fluid pressure leading to a hydraulic fracture of the wellbore wall or drilling through a permeable or/and naturally fractured formation.

Predicting such mud loss, and thus mud usage in general, may facilitate avoiding expenses associated with having too much drilling mud on hand, or delays and expenses associated with having too little drilling mud on hand.

### SUMMARY

Embodiments of the disclosure may provide a method for predicting drilling fluid loss rate. The method includes obtaining data representing a drilling fluid loss rate from a first well while drilling the first well, and obtaining a mechanical earth model of a subterranean volume. The first well extends at least partially through the subterranean volume, and the mechanical earth model includes data representing formation strain in the subterranean volume. The method also includes determining a relationship between the formation strain and the drilling fluid loss rate, and predicting a drilling fluid loss rate in a second well extending through the subterranean volume based at least in part on the relationship.

In an embodiment, determining the relationship includes determining the formation strain at a plurality of depths in the subterranean volume along the first well, determining the drilling fluid loss rate while drilling the first well at the plurality of depths, and generating a plot of the drilling fluid loss rate versus the formation strain at the plurality of depths.

In an embodiment, determining the relationship includes performing a statistical regression analysis of the plot.

In an embodiment, the method also includes generating a visualization of the subterranean volume representing at least the predicted drilling fluid loss rate.

In an embodiment, the method further includes generating a visualization of the predicted drilling fluid loss rate in the second well.

In an embodiment, the method also includes displaying an observed drilling fluid loss rate in the second well in the visualization.

In an embodiment, obtaining the mechanical earth model includes generating a three-dimensional mechanical earth model based on data representing one or more physical characteristics of the subterranean volume, and performing a numerical simulation of stress, strain, or both for at least a portion of the subterranean volume.

Embodiments of the disclosure may also provide a computing system including one or more processors, and a memory system comprising one or more non-transitory, computer-readable media storing instructions that, when executed by at least one of the one or more processors, cause the computing system to perform operations. The operations include obtaining data representing a drilling fluid loss rate from a first well while drilling the first well, and obtaining a mechanical earth model of a subterranean volume. The first well extends at least partially through the subterranean volume, and the mechanical earth model includes data representing formation strain in the subterranean volume. The operations also includes determining a relationship between the formation strain and the drilling fluid loss rate, and predicting a drilling fluid loss rate in a second well extending through the subterranean volume based at least in part on the relationship.

Embodiments of the disclosure may further provide a non-transitory, computer-readable medium storing instructions that, when executed by at least one processor of a computing system, cause the computing system to perform operations. The operations include obtaining data representing a drilling fluid loss rate from a first well while drilling the first well, and obtaining a mechanical earth model of a subterranean volume. The first well extends at least partially through the subterranean volume, and the mechanical earth model includes data representing formation strain in the subterranean volume. The operations also includes determining a relationship between the formation strain and the drilling fluid loss rate, and predicting a drilling fluid loss rate in a second well extending through the subterranean volume based at least in part on the relationship.

Embodiments of the disclosure may further provide a computing system including one or more processors and configured to obtain data representing a drilling fluid loss rate from a first well while drilling the first well, and obtain a mechanical earth model of a subterranean volume. The first well extends at least partially through the subterranean volume, and the mechanical earth model includes data representing formation strain in the subterranean volume. The computing system is further configured to determine a relationship between the formation strain and the drilling fluid loss rate, and predict a drilling fluid loss rate in a second well extending through the subterranean volume based at least in part on the relationship.

Embodiments of the disclosure may also provide a computing system including means for obtaining data representing a drilling fluid loss rate from a first well while drilling the first well, and means for obtaining a mechanical earth model of a subterranean volume. The first well extends at least partially through the subterranean volume, and the mechanical earth model includes data representing formation strain in the subterranean volume. The system also includes means for determining a relationship between the formation strain and the drilling fluid loss rate, and means for predicting a drilling fluid loss rate in a second well extending through the subterranean volume based at least in part on the relationship.

It will be appreciated that the foregoing summary is not intended to be exhaustive or in any way limiting on the following description, but merely serves to introduce a subset of the concepts described below.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIGS. 1A, 1B, 1C, 1D, 2, 3A, and 3B illustrate simplified, schematic views of an oilfield and its operation, according to an embodiment.

FIG. 4 illustrates a flowchart of a method for predicting drilling fluid loss in a well, according to an embodiment.

FIG. 5 illustrates a plot of strain versus drilling fluid loss, according to an embodiment.

FIG. 6 illustrates another plot of strain versus drilling fluid loss, according to an embodiment.

FIG. 7A illustrates a visualization of a subterranean volume showing predicted drilling fluid loss in subvolumes thereof, according to an embodiment.

FIG. 7B illustrates a visualization of a subterranean volume showing predicted drilling fluid loss and wells, according to an embodiment.

FIGS. 8A and 8B illustrate visualizations of attributes of a well, including predicted and observed drilling fluid loss, according to an embodiment.

FIGS. 9A and 9B illustrate a flowchart of a method for predicting drilling fluid loss, according to an embodiment.

FIG. 10 illustrates a schematic view of a computing system, according to an embodiment.

### DESCRIPTION OF EMBODIMENTS

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object could be termed a second object and, similarly, a second object could be termed a first object without departing from the scope of the invention. The first object and the second object are both objects but they are not to be considered the same object.

The terminology used in the description of the invention herein is for the purpose of describing particular embodiments only and is not intended to be limiting of the invention. As used in the description of the invention and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques and workflows that are in accordance with some embodiments. Some operations in the processing procedures, methods, techniques and workflows disclosed herein may be combined and/or the order of some operations may be changed.

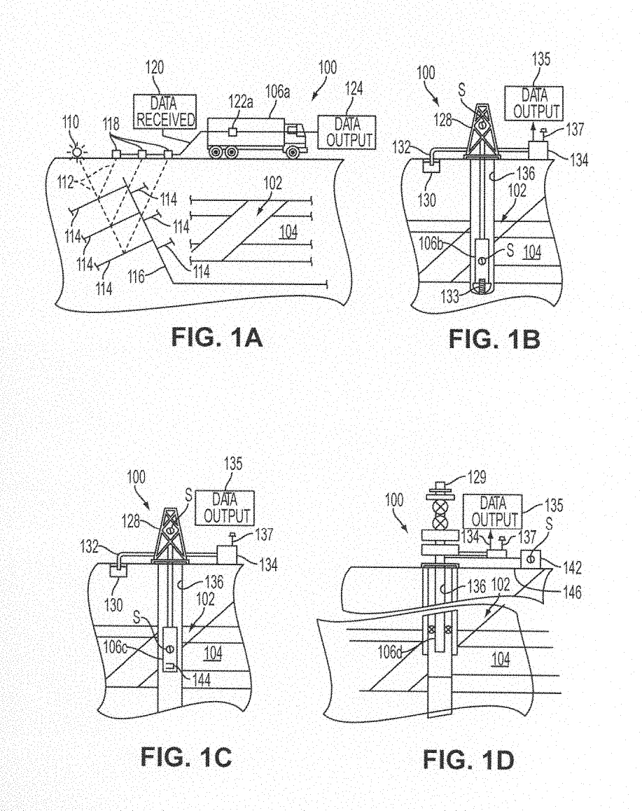

FIGS. 1A-1D illustrate simplified, schematic views of oilfield 100 having subterranean formation 102 containing reservoir 104 therein in accordance with implementations of various technologies and techniques described herein. FIG. 1A illustrates a survey operation being performed by a survey tool, such as seismic truck 106.1, to measure properties of the subterranean formation. The survey operation is a seismic survey operation for producing sound vibrations. In FIG. 1A, one such sound vibration, e.g., sound vibration 112 generated by source 110, reflects off horizons 114 in earth formation 116. A set of sound vibrations is received by sensors, such as geophone-receivers 118, situated on the earth's surface. The data received 120 is provided as input data to a computer 122.1 of a seismic truck 106.1, and responsive to the input data, computer 122.1 generates seismic data output 124. This seismic data output may be stored, transmitted or further processed as desired, for example, by data reduction.

FIG. 1B illustrates a drilling operation being performed by drilling tools 106.2 suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is typically filtered and returned to the mud pit. A circulating system may be used for storing, controlling, or filtering the flowing drilling mud. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

Sensors (S), such as gauges, may be positioned about oilfield 100 to collect data relating to various oilfield operations as described previously. As shown, sensor (S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors (S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

The wellbore may be drilled according to a drilling plan that is established prior to drilling. The drilling plan may set forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected

The data gathered by sensors (S) may be collected by surface unit 134 and/or other data collection sources for analysis or other processing. The data collected by sensors (S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 1C illustrates a wireline operation being performed by wireline tool 106.3 suspended by rig 128 and into wellbore 136 of FIG. 1B. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein.

Wireline tool 106.3 may be operatively connected to, for example, geophones 118 and a computer 122.1 of a seismic truck 106.1 of FIG. 1A. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors (S), such as gauges, may be positioned about oilfield 100 to collect data relating to various field operations as described previously. As shown, sensor S is positioned in wireline tool 106.3 to measure downhole parameters which relate to, for example porosity, permeability, fluid composition and/or other parameters of the field operation.

FIG. 1D illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors (S), such as gauges, may be positioned about oilfield 100 to collect data relating to various field operations as described previously. As shown, the sensor (S) may be positioned in production tool 106.4 or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1B-1D illustrate tools used to measure properties of an oilfield, it will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 1A-1D are intended to provide a brief description of an example of a field usable with oilfield application frameworks. Part of, or the entirety, of oilfield 100 may be on land, water and/or sea. Also, while a single field measured at a single location is depicted, oilfield applications may be utilized with any combination of one or more oilfields, one or more processing facilities and one or more wellsites.

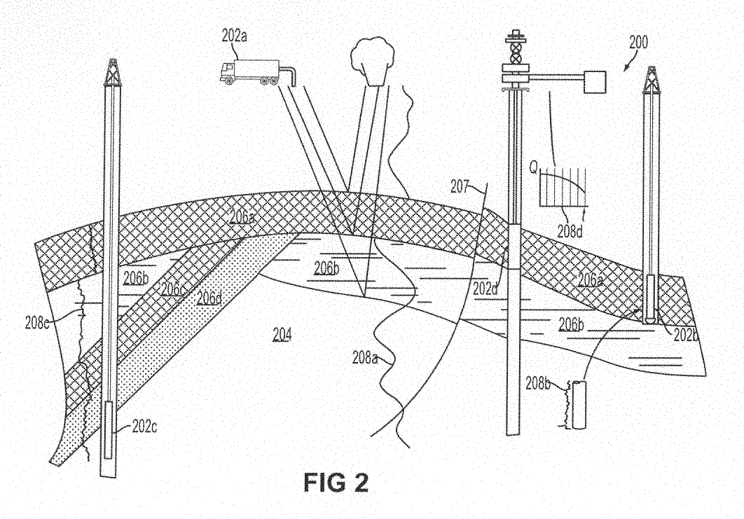

FIG. 2 illustrates a schematic view, partially in cross section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 1A-1D, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively; however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that typically provides a resistivity or other measurement of the formation at various depths.

A production decline curve or graph 208.4 is a dynamic data plot of the fluid flow rate over time. The production decline curve typically provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 2, may then be processed and/or evaluated. Typically, seismic data displayed in static data plot 208.1 from data acquisition tool 202.1 is used by a geophysicist to determine characteristics of the subterranean formations and features. The core data shown in static plot 208.2 and/or log data from well log 208.3 are typically used by a geologist to determine various characteristics of the subterranean formation. The production data from graph 208.4 is typically used by the reservoir engineer to determine fluid flow reservoir characteristics. The data analyzed by the geologist, geophysicist and the reservoir engineer may be analyzed using modeling techniques.

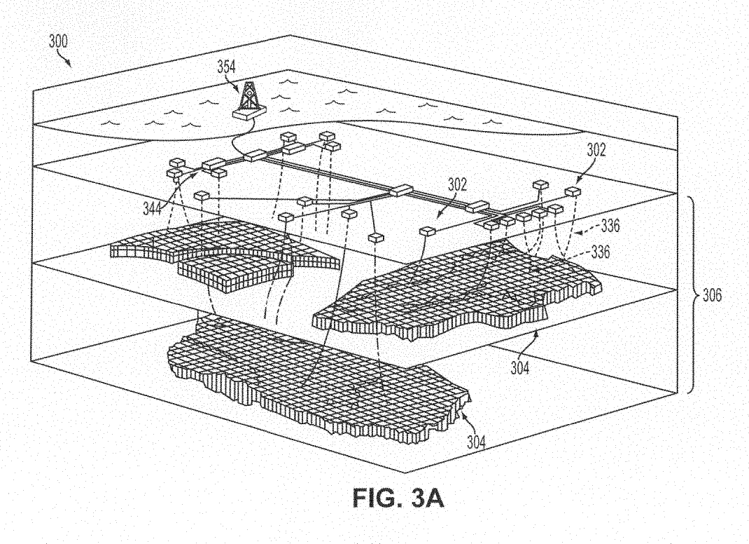

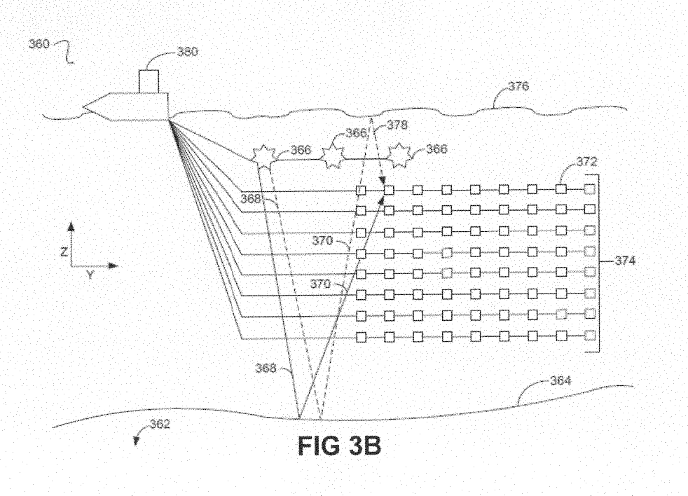

FIG. 3A illustrates an oilfield 300 for performing production operations in accordance with implementations of various technologies and techniques described herein. As shown, the oilfield has a plurality of wellsites 302 operatively connected to central processing facility 354. The oilfield configuration of FIG. 3A is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

Attention is now directed to FIG. 3B, which illustrates a side view of a marine-based survey 360 of a subterranean subsurface 362 in accordance with one or more implementations of various techniques described herein. Subsurface 362 includes seafloor surface 364. Seismic sources 366 may include marine sources such as vibroseis or airguns, which may propagate seismic waves 368 (e.g., energy signals) into the Earth over an extended period of time or at a nearly instantaneous energy provided by impulsive sources. The seismic waves may be propagated by marine sources as a frequency sweep signal. For example, marine sources of the vibroseis type may initially emit a seismic wave at a low frequency (e.g., 5 Hz) and increase the seismic wave to a high frequency (e.g., 80-90 Hz) over time.

The component(s) of the seismic waves 368 may be reflected and converted by seafloor surface 364 (i.e., reflector), and seismic wave reflections 370 may be received by a plurality of seismic receivers 372. Seismic receivers 372 may be disposed on a plurality of streamers (i.e., streamer array 374). The seismic receivers 372 may generate electrical signals representative of the received seismic wave reflections 370. The electrical signals may be embedded with information regarding the subsurface 362 and captured as a record of seismic data.

In one implementation, each streamer may include streamer steering devices such as a bird, a deflector, a tail buoy and the like, which are not illustrated in this application. The streamer steering devices may be used to control the position of the streamers in accordance with the techniques described herein.

In one implementation, seismic wave reflections 370 may travel upward and reach the water/air interface at the water surface 376, a portion of reflections 370 may then reflect downward again (i.e., sea-surface ghost waves 378) and be received by the plurality of seismic receivers 372. The sea-surface ghost waves 378 may be referred to as surface multiples. The point on the water surface 376 at which the wave is reflected downward is generally referred to as the downward reflection point.

The electrical signals may be transmitted to a vessel 380 via transmission cables, wireless communication or the like. The vessel 380 may then transmit the electrical signals to a data processing center. Alternatively, the vessel 380 may include an onboard computer capable of processing the electrical signals (i.e., seismic data). Those skilled in the art having the benefit of this disclosure will appreciate that this illustration is highly idealized. For instance, surveys may be of formations deep beneath the surface. The formations may typically include multiple reflectors, some of which may include dipping events, and may generate multiple reflections (including wave conversion) for receipt by the seismic receivers 372. In one implementation, the seismic data may be processed to generate a seismic image of the subsurface 362.

Marine seismic acquisition systems tow each streamer in streamer array 374 at the same depth (e.g., 5-10 m). However, marine based survey 360 may tow each streamer in streamer array 374 at different depths such that seismic data may be acquired and processed in a manner that avoids the effects of destructive interference due to sea-surface ghost waves. For instance, marine-based survey 360 of FIG. 3B illustrates eight streamers towed by vessel 380 at eight different depths. The depth of each streamer may be controlled and maintained using the birds disposed on each streamer.

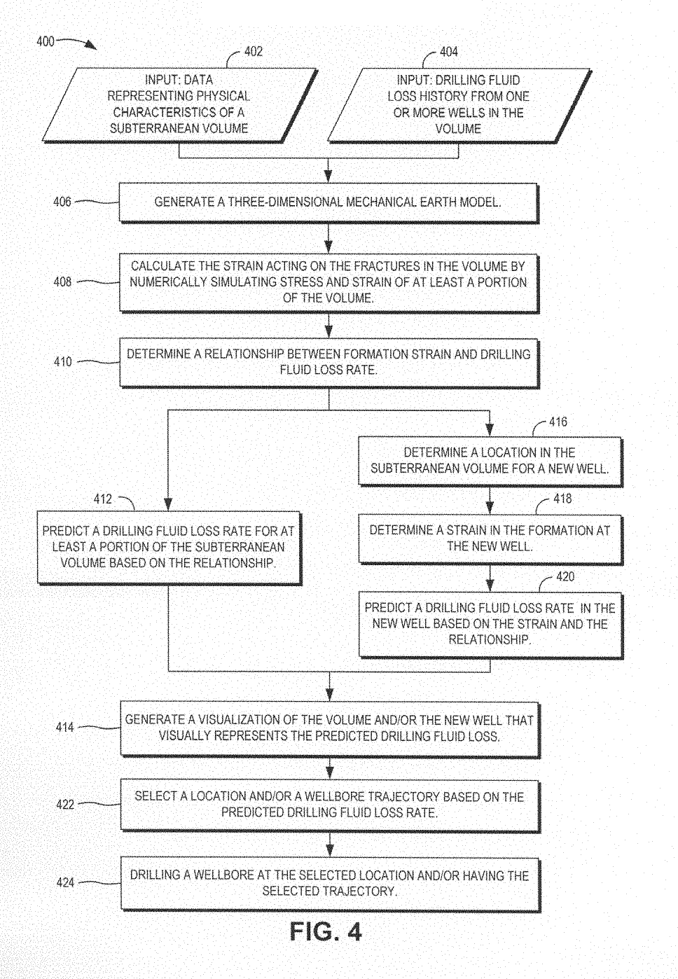

FIG. 4 illustrates a flowchart of a method 400 for predicting drilling fluid loss, according to an embodiment. The method 400 may begin by receiving various types of input data for a subterranean volume of interest, e.g., an oilfield. For example, the method 400 may include obtaining data representing one or more physical characteristics of the subterranean volume, as at 402. Such data my include geophysical logs, seismic data, a discrete fracture network, mechanical core tests, breakouts and induced fractures from image logs, and leak-off test results. Further, this data may be collected prior to the method 400, or the collection thereof may be part of the method 400.

Further, the method 400 may also include obtaining, as input, a drilling fluid loss history from one or more wells in the oilfield that traverse the subterranean volume, as at 404. The drilling fluid loss history may record a drilling fluid loss for one or more wells previously drilled in the subterranean volume. The drilling fluid loss history may record the rate and/or volume of drilling fluid loss according to drilling depth, and may also include additional information such as notations of “mud-loss” events, e.g., where a rate of loss exceeded a threshold. Such mud-loss events may be caused by a variety of circumstances, such as when the drill bit encounters natural fissures, fractures or caverns, and mud flows into the newly-available space.

With these, and/or any other inputs, obtained, the method 400 may include generating a model of the subterranean volume, as at 406. In some embodiments, the model may be a Mechanical Earth Model (MEM), for example, a three-dimensional MEM. To generate such a three-dimensional MEM at 406, a one-dimensional MEM may initially be created, and a team of petrophysicists, geomechanics rock physicists, geologists, and geophysicists may analyze the geological and geophysical data and generate the three-dimensional MEM. For example, tertiary pore pressure cubes may be calibrated against well events and inverted, allowing analyzation of effective stress-to-velocity transforms. Further, Mesozoic pore pressure cube from carbonated formation may be inverted using direct measurement in reservoirs. Generating the model at 406 may also include constraining a discrete fracture network model, with natural fractures interpreted from borehole images, as well as identifying faults, horizons, and rock-physics attributes within the model.

The three-dimensional model generated at 406 may be employed as input for a numerical simulation. In particular, the method 400 may include calculating the elastic and plastic strain acting on the fractures by performing a numerical stress-strain simulation using the model, as at 408.

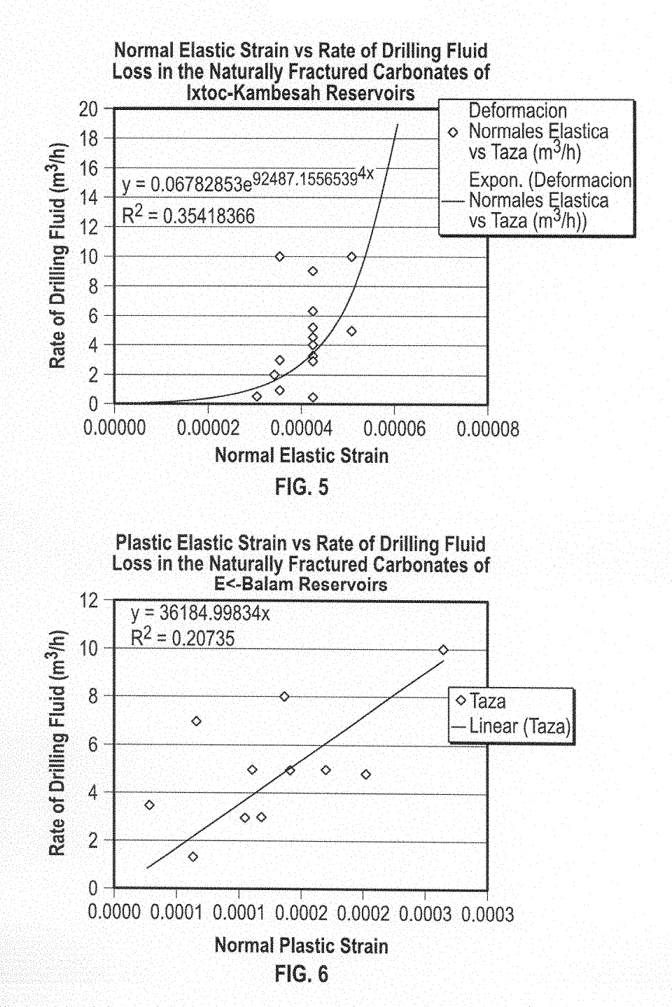

The simulation of the 3D model includes the change of the reservoir pressure over time with production or injection (i.e., the 4D model) and may establish the strain acting on natural fractures at any given location. The method 400 may then include determining a relationship between the strain and the drilling fluid loss, as at 410. FIGS. 5 and 6 illustrate two plots, showing two examples of a determined relationship of drilling fluid loss (Y-axis) and normal plastic strain (X-axis). In an embodiment, this relationship may, as shown, be established by comparing the drilling fluid loss rate histories with the simulated, normal plastic strain. For example, the drilling fluid loss histories may establish a location of the drill bit at a particular time, at a particular reservoir pressure and a drilling fluid loss rate at that time. Thus, the two attributes may be plotted, as shown. A statistical operation, such as a regression analysis, may then be performed to determine a relationship (e.g., correlation) between the rate of drilling fluid loss and the strain, with the location (e.g., depth) being the linking factor between the two. The regression may result in, for example, a linear relationship, as shown in FIG. 5, an exponential relationship, as shown in FIG. 6, or any other type of relationship.

The method 400 may then, in at least some embodiments, including predicting a drilling fluid loss rate for at least a portion of the subterranean volume based on the relationship, as at 412. For example, an additional attribute may be added to the model of the subterranean volume. The attribute may be indicated for at least some sub-volumes of the model, and may provide the expected drilling loss rate in a well that traverses the individual sub-volume.

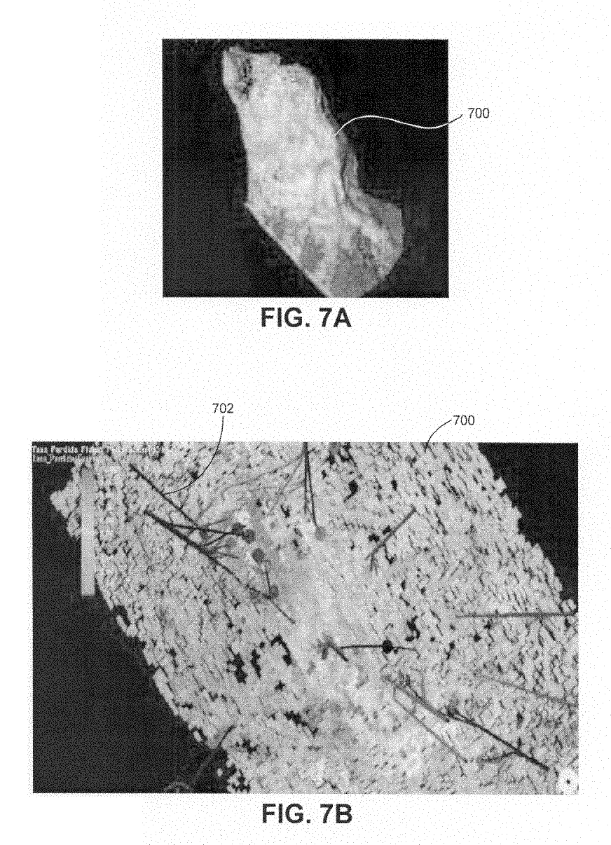

A visualization of the modeled subterranean volume, illustrating the new attribute, may then be generated, effectively modifying the real-world data represented in the model, as at 414. FIGS. 7A and 7B illustrate examples of such an attribute in a modeled subterranean volume 700. As shown in both, subvolumes of the subterranean volume 700 may be provided with a visual representation of the attribute, which may be considered, for example, during well planning Further, in FIG. 7B, a portion of the subterranean volume 700 may be illustrated, e.g., a particular geological area, horizon, etc., along with one or more wells 702 extending therein. It will be appreciated that these visualizations are but two examples, and others may be provided. For example, some visualizations may include a future prediction of variation of the fluid loss rate with planned change in reservoir pressure through production and/or injection.

In an embodiment, in addition to or instead of predicting the drilling fluid loss for at least a portion of the subterranean volume, the method 400 may consider drilling fluid loss on a per-well basis. That is, for example, the method 400 may include determining a location within the subterranean volume for a new well, as at 416. The location may be a well plan, which may provide a geometry for the well extending in the subterranean volume. The method 400 may also include determining a strain in the formation at the location of the new well, as at 418. For example, this may proceed by obtaining from the results of the simulation (e.g., in the 4D MEM) the data representing the strain at the location(s) along the new well in the formation. The method 400 may then include predicting a drilling fluid loss in the new well, based on the strain and the relationship determined at 410, as at 420. The predicted drilling fluid loss may be predicted at one or more drilling depths, e.g., at various points during the drilling operation.

In this embodiment too, the method 400 may then proceed to generating a visualization of the predicted drilling fluid loss, as at 414. Instead of, or in addition to, representing this attribute in the modeled subterranean volume, the attribute may be visualized along a length of a well. The visualization may include columns or tracks showing forecasted conditions. The visualization may also or instead include tracks showing observations or measurements made during the drilling process, e.g., once a well plan is accepted and implemented, which may be used to verify or adjust the relationship determined at 410.

In some embodiments, the method 400 may also include selecting a drilling location and/or wellbore trajectory based at least in part on the predicted drilling fluid loss rate, as at 422, and drilling a wellbore at the location and/or having the selected trajectory, as at 424. This may take the form of a new wellbore, or a modification to the trajectory of an incomplete well.

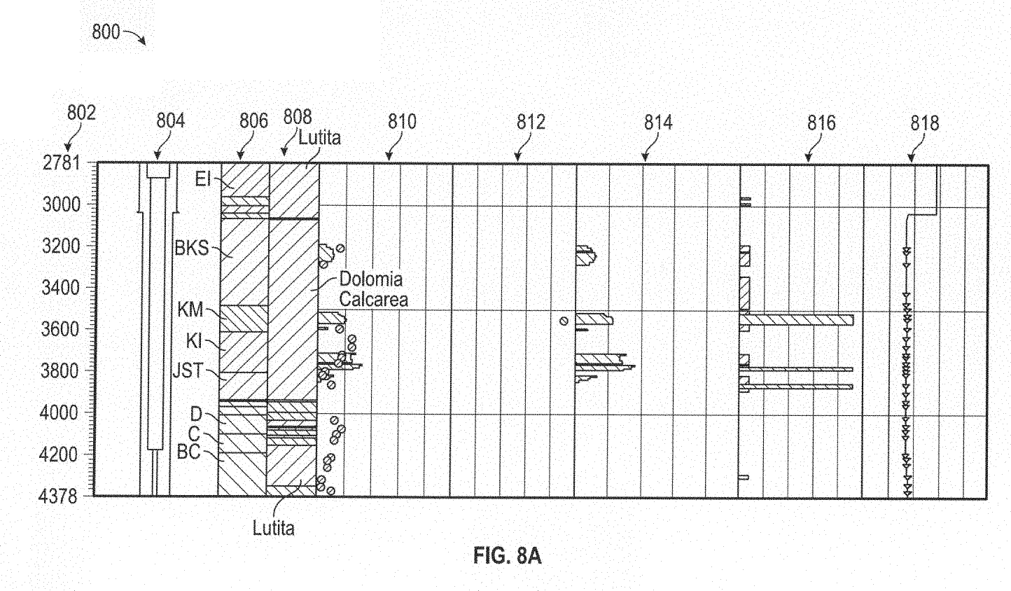

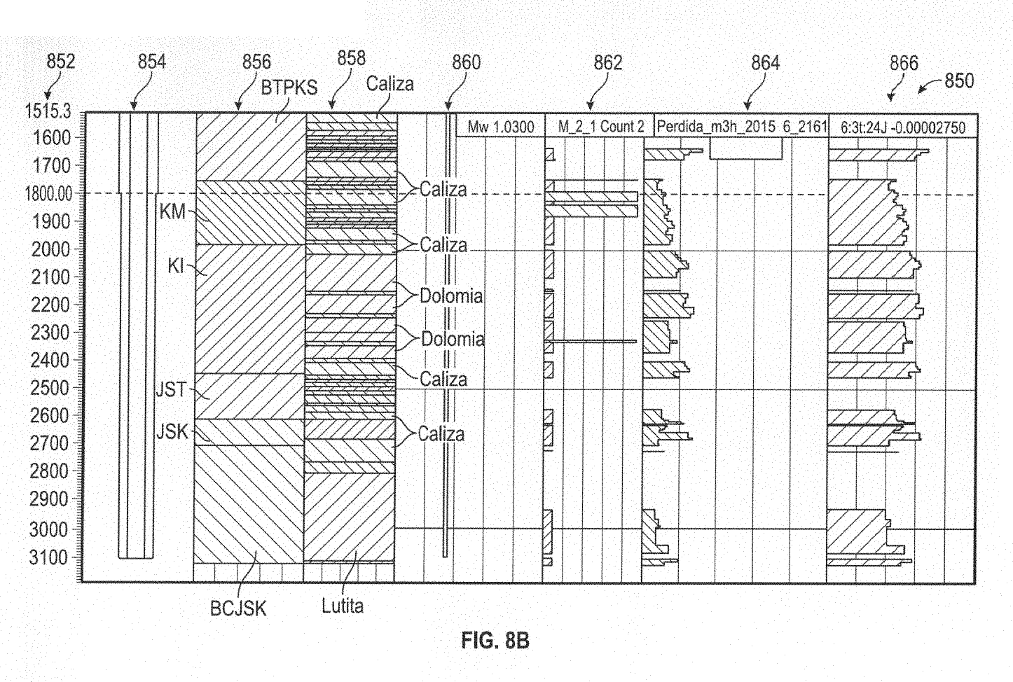

FIG. 8A illustrates a first example of a visualization 800, according to an embodiment. In particular, the visualization 800 may depict conditions recorded while drilling a well and/or predicted based on the determined relationship. Such data may then be employed to determine or refine the determined relationship. In the illustrated embodiment, the visualization 800 includes nine columns 802, 804, 806, 808, 810, 812, 814, 816, 818. The first column 802 may represent a depth in the well. The second column 804 may represent a completion characteristic (e.g., casing diameter) in the well along the depth. The third column 806 may represent a mechanical geology of the formation along the depth. It will be appreciated that the formation may be naturally fractured. The fourth column 808 may represent a lithology of the formation. The fifth column 810 may represent a predicted rate of drilling fluid loss, and an observed rate of drilling fluid loss. The sixth column 812 may represent a plastic strain on the fractures of the formation. The seventh column 814 may represent cells with natural fractures. The eighth column 816 may represent a planned mud weight and observed drilling fluid loss.

FIG. 8B illustrates another example of a visualization 850, according to an embodiment. In particular, the visualization 850 may depict predictions for a planned well based on the relationship. The visualization 850 may include eight columns. The first column 852 may represent depth in the well. The second column 854 may represent a completion characteristic (e.g., casing diameter). The third column 856 may represent a geology of the formation. The fourth column 858 may represent a lithology of the formation. The fifth column 860 may represent a planned mud weight. The sixth column 862 may represent cells with natural fractures. The seventh column 864 may represent a predicted rate of drilling fluid loss, e.g., in cubic meters per hour. The eighth column 866 may represent a formation strain of the naturally fractured medium.

It will be appreciated that per-well visualizations and/or the visualizations of the subterranean volume may graphically depict the well extending through the subterranean formation.

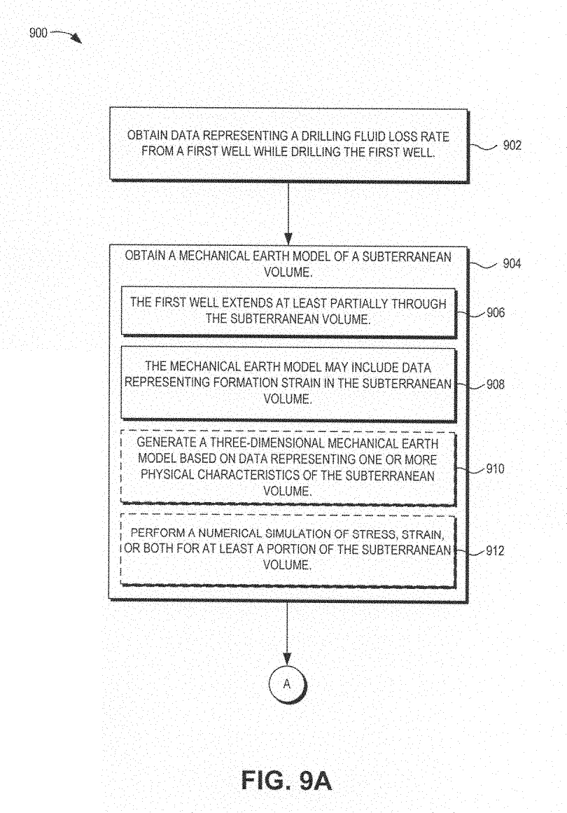

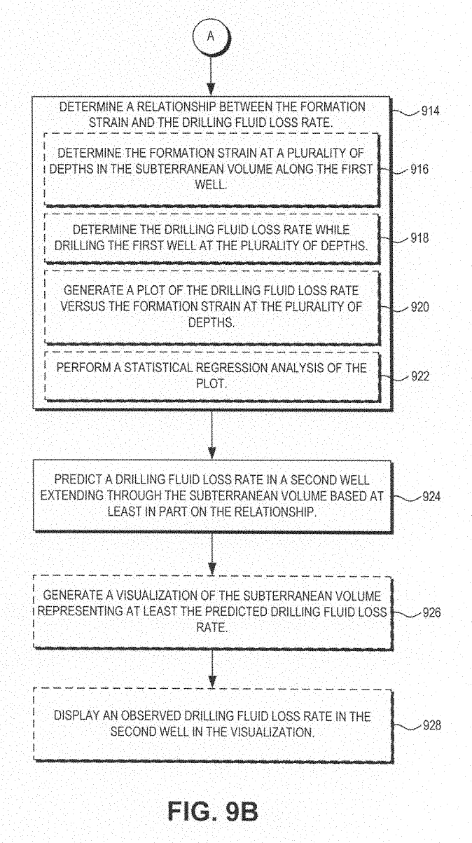

FIGS. 9A and 9B illustrate a flowchart of a method 900 for predicting drilling fluid loss rate, according to an embodiment. It will be appreciated that the flowchart depicts merely one embodiment of the method 900. The illustrated aspects of the method 900 may be combined, separated, or performed in an order that is different than that illustrated.

The method 900 may include obtaining data representing a drilling fluid loss rate from a first well while drilling the first well, as at 902 (e.g., FIG. 4, 404, receiving drilling fluid loss history). The method 900 may also include obtaining a mechanical earth model of a subterranean volume, as at 904 (e.g., FIG. 4, 406, generating a mechanical earth model). In an embodiment, the first well extends at least partially through the subterranean volume, as at 906 (e.g., FIG. 4, 404, the one or more wells are in the volume). Further, the mechanical earth model may include data representing formation strain in the subterranean volume, as at 908 (e.g., FIG. 4, 408, calculating the strain for input into the mechanical earth model). Moreover, obtaining at 904 may include generating a three-dimensional mechanical earth model based on data representing one or more physical characteristics of the subterranean volume, as at 910 (e.g., FIG. 4, 406, the mechanical earth model is a three-dimensional model). Obtaining at 904 may additionally include performing a numerical simulation of stress, strain, or both for at least a portion of the subterranean volume, as at 912 (e.g., FIG. 4, 408, numerically simulating stress and strain).

The method 900 may further include determining a relationship between the formation strain and the drilling fluid loss rate, as at 914 (e.g., FIG. 4, 410, determining a relationship between strain and fluid loss rate). In an embodiment, determining at 914 may include determining the formation strain at a plurality of depths in the subterranean volume along the first well, as at 916. Determining at 914 may also include determining the drilling fluid loss rate while drilling the first well at the plurality of depths, as at 918. Determining at 914 may further include generating a plot of the drilling fluid loss rate versus the formation strain at the plurality of depths, as at 920. In an embodiment, determining at 914 may include performing a statistical regression analysis of the plot, as at 922.

The method 900 may also include predicting a drilling fluid loss rate in a second well extending through the subterranean volume based at least in part on the relationship, as at 924 (e.g., FIG. 4, 412 or 420, predicting the drilling fluid loss rate based on the relationship).

The method 900 may also include generating a visualization of the subterranean volume representing at least the predicted drilling fluid loss rate, as at 926 (e.g., FIG. 4, 414, generating the visualization). In an embodiment, the method 900 may further include displaying an observed drilling fluid loss rate in the second well in the visualization, as at 928.

In one or more embodiments, the functions described can be implemented in hardware, software, firmware, or any combination thereof. For a software implementation, the techniques described herein can be implemented with modules (e.g., procedures, functions, subprograms, programs, routines, subroutines, modules, software packages, classes, and so on) that perform the functions described herein. A module can be coupled to another module or a hardware circuit by passing and/or receiving information, data, arguments, parameters, or memory contents. Information, arguments, parameters, data, or the like can be passed, forwarded, or transmitted using any suitable means including memory sharing, message passing, token passing, network transmission, and the like. The software codes can be stored in memory units and executed by processors. The memory unit can be implemented within the processor or external to the processor, in which case it can be communicatively coupled to the processor via various means as is known in the art.

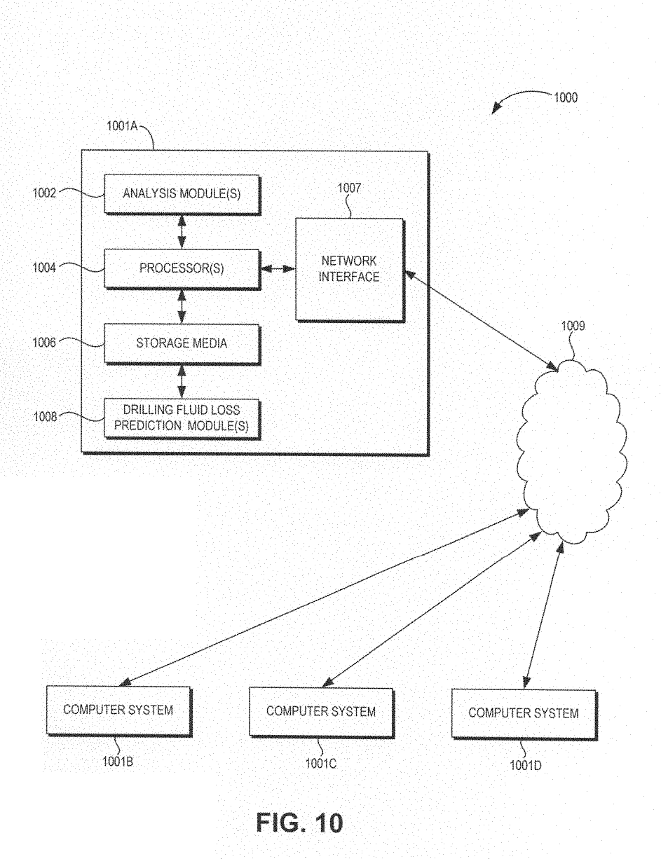

In some embodiments, any of the methods of the present disclosure may be executed by a computing system. FIG. 10 illustrates an example of such a computing system 1000, in accordance with some embodiments. The computing system 1000 may include a computer or computer system 1001A, which may be an individual computer system 1001A or an arrangement of distributed computer systems. The computer system 1001A includes one or more analysis module(s) 1002 configured to perform various tasks according to some embodiments, such as one or more methods disclosed herein. To perform these various tasks, the analysis module 1002 executes independently, or in coordination with, one or more processors 1004, which is (or are) connected to one or more storage media 1006. The processor(s) 1004 is (or are) also connected to a network interface 1007 to allow the computer system 1001A to communicate over a data network 1009 with one or more additional computer systems and/or computing systems, such as 1001B, 1001C, and/or 1001D (note that computer systems 1001B, 1001C and/or 1001D may or may not share the same architecture as computer system 1001A, and may be located in different physical locations, e.g., computer systems 1001A and 1001B may be located in a processing facility, while in communication with one or more computer systems such as 1001C and/or 1001D that are located in one or more data centers, and/or located in varying countries on different continents).

A processor can include a microprocessor, microcontroller, processor module or subsystem, programmable integrated circuit, programmable gate array, or another control or computing device.

The storage media 1006 can be implemented as one or more computer-readable or machine-readable storage media. Note that while in the example embodiment of FIG. 10 storage media 1006 is depicted as within computer system 1001A, in some embodiments, storage media 1006 may be distributed within and/or across multiple internal and/or external enclosures of computing system 1001A and/or additional computing systems. Storage media 1006 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURRY® disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In some embodiments, computing system 1000 contains one or more drilling fluid loss prediction module(s) 1008. In the example of computing system 1000, computer system 1001A includes the drilling fluid loss prediction module 1008. In some embodiments, a single drilling fluid loss prediction module may be used to perform some or all aspects of one or more embodiments of the methods. In alternate embodiments, a plurality of drilling fluid loss prediction modules may be used to perform some or all aspects of methods.

It should be appreciated that computing system 1000 is only one example of a computing system, and that computing system 1000 may have more or fewer components than shown, may combine additional components not depicted in the example embodiment of FIG. 10, and/or computing system 1000 may have a different configuration or arrangement of the components depicted in FIG. 10. The various components shown in FIG. 10 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

Geologic interpretations, models and/or other interpretation aids may be refined in an iterative fashion; this concept is applicable to embodiments of the present methods discussed herein. This can include use of feedback loops executed on an algorithmic basis, such as at a computing device (e.g., computing system 1000, FIG. 10), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. Moreover, the order in which the elements of the methods are illustrated and described may be re-arranged, and/or two or more elements may occur simultaneously. The embodiments were chosen and described in order to best explain the principals of the invention and its practical applications, to thereby enable others skilled in the art to best utilize the invention and various embodiments with various modifications as are suited to the particular use contemplated.

What is claimed is:

1. A method for predicting drilling fluid loss rate, comprising:
obtaining data representing a drilling fluid loss rate from a first well while drilling the first well;
obtaining a mechanical earth model of a subterranean volume, wherein the first well extends at least partially through the subterranean volume, and wherein the mechanical earth model comprises data representing formation strain in the subterranean volume;
determining a relationship between the formation strain and the drilling fluid loss rate; and
predicting a drilling fluid loss rate in a second well extending through the subterranean volume based at least in part on the relationship.

2. The method of claim 1, wherein determining the relationship comprises:
determining the formation strain at a plurality of depths in the subterranean volume along the first well;
determining the drilling fluid loss rate while drilling the first well at the plurality of depths; and
generating a plot of the drilling fluid loss rate versus the formation strain at the plurality of depths.

3. The method of claim 2, wherein determining the relationship comprises performing a statistical regression analysis of the plot.

4. The method of claim 1, further comprising generating a visualization of the subterranean volume representing at least the predicted drilling fluid loss rate.

5. The method of claim 1, further comprising generating a visualization of the predicted drilling fluid loss rate in the second well.

6. The method of claim 5, further comprising displaying an observed drilling fluid loss rate in the second well in the visualization.

7. The method of claim 1, wherein obtaining the mechanical earth model comprises:
generating a three-dimensional mechanical earth model based on data representing one or more physical characteristics of the subterranean volume; and
performing a numerical simulation of stress, strain, or both for at least a portion of the subterranean volume.

8. A computing system, comprising:
one or more processors; and
a memory system comprising one or more non-transitory, computer-readable media storing instructions that, when executed by at least one of the one or more processors, cause the computing system to perform operations, the operations comprising:
obtaining data representing a drilling fluid loss rate from a first well while drilling the first well;
obtaining a mechanical earth model of a subterranean volume, wherein the first well extends at least partially through the subterranean volume, and wherein the mechanical earth model comprises data representing formation strain in the subterranean volume;
determining a relationship between the formation strain and the drilling fluid loss rate; and
predicting a drilling fluid loss rate in a second well extending through the subterranean volume based at least in part on the relationship.

9. The system of claim 8, wherein determining the relationship comprises:
determining the formation strain at a plurality of depths in the subterranean volume along the first well;
determining the drilling fluid loss rate while drilling the first well at the plurality of depths; and
generating a plot of the drilling fluid loss rate versus the formation strain at the plurality of depths.

10. The system of claim 9, wherein determining the relationship comprises performing a statistical regression analysis of the plot.

11. The system of claim 8, wherein the operations further comprise generating a visualization of the subterranean volume representing at least the predicted drilling fluid loss rate.

12. The system of claim 8, further comprising a display, wherein the operations further comprise:
generating a visualization of the predicted drilling fluid loss rate in the second well; and
displaying the visualization in the display.

13. The system of claim 12, wherein the operations further comprise displaying an observed drilling fluid loss rate in the second well in the visualization.

14. The system of claim 8, wherein obtaining the mechanical earth model comprises:
generating a three-dimensional mechanical earth model based on data representing one or more physical characteristics of the subterranean volume; and
performing a numerical simulation of stress, strain, or both for at least a portion of the subterranean volume.

15. A non-transitory, computer-readable medium storing instructions that, when executed by at least one processor of a computing system, cause the computing system to perform operations, the operations comprising:
obtaining data representing a drilling fluid loss rate from a first well while drilling the first well;
obtaining a mechanical earth model of a subterranean volume, wherein the first well extends at least partially through the subterranean volume, and wherein the mechanical earth model comprises data representing formation strain in the subterranean volume;
determining a relationship between the formation strain and the drilling fluid loss rate; and
predicting a drilling fluid loss rate in a second well extending through the subterranean volume based at least in part on the relationship.

16. The medium of claim 15, wherein determining the relationship comprises:
determining the formation strain at a plurality of depths in the subterranean volume along the first well;
determining the drilling fluid loss rate while drilling the first well at the plurality of depths; and
generating a plot of the drilling fluid loss rate versus the formation strain at the plurality of depths.

17. The medium of claim 16, wherein determining the relationship comprises performing a statistical regression analysis of the plot.

18. The medium of claim 15, wherein the operations further comprise generating a visualization of the subterranean volume representing at least the predicted drilling fluid loss rate.

19. The medium of claim 15, further comprising a display, wherein the operations further comprise:
generating a visualization of the predicted drilling fluid loss rate in the second well; and
displaying the visualization in the display.

20. The medium of claim 15, wherein obtaining the mechanical earth model comprises:
generating a three-dimensional mechanical earth model based on data representing one or more physical characteristics of the subterranean volume; and
performing a numerical simulation of stress, strain, or both for at least a portion of the subterranean volume.
